(19) United States
(12) Patent Application Publication
(10) Pub. No.: US 2001/0022097 A1
(43) Pub. Date: Sep. 20, 2001

(54) Lock

(76) Inventor: Michael Bremicker, Rehe (DE)

Correspondence Address: J. Georg Seka, TOWNSEND and TOWSEND and CREW LLP, Two Embarcadero Center, 8th Floor, San Francisco, CA, 94111-3834, US

(21) Appl. No.: 09/777,006

(22) Filed: Feb. 2, 2001

(30) Foreign Application Priority Data
Feb. 3, 2000 (DE) 100 04 602.9

(51) Int. Cl. E05B 67/22

(52) U.S. Cl. 70/38 R

(57) ABSTRACT

A lock, in particular a hoop or cable lock, having a lock bolt which can be locked in place in a lock bolt recess of a lock housing, with the lock bolt being loaded in the locked state of the lock by a pad element in the direction of its unlocked position via its end face.

The invention relates to a lock, in particular a hoop or cable lock, having a lock bolt which can be locked in place in a lock bolt recess of a lock housing.

Such locks are used, for example, to secure bicycles in their unused state, with it being desirable to take these locks along when the bicycle is being used, so that the bicycle can be secured at any place. Locks of the prior art are fastened to the bicycle for this purpose by means of special holders when the bicycle is being used.

It is a disadvantage with the known locks that the lock bolt is held in the lock housing usually with a small clearance, which results in relative movements occurring between the lock bolt and the lock housing when the bicycle is being used, when the lock is fixed in the holder; said relative movements are caused by vibrations of the bicycle and finally result in an irritating rattling.

An object of the invention is to further develop a lock of the kind initially mentioned such that rattling noises are reduced or even avoided during vibrations.

This object is satisfied in accordance with the invention in that the lock bolt is loaded in the locked state of the lock by a pad element in the direction of its unlocked position via its end face.

Since the pad element provided in accordance with the invention loads the lock bolt in the direction of its unlocked position in the locked state of the lock, any possible clearance between the lock bolt and the lock bolt recess is taken up or compensated so that no relative movements or only very small relative movements are possible between the lock bolt and the lock bolt recess when the lock bolt is locked in the lock bolt recess. A rattling of the lock in the case of vibrations is greatly reduced or completely avoided by this reduction or elimination of the clearance between the lock bolt and the lock bolt recess.

The pad element in accordance with the invention is preferably made of foam, in particular of fine-pored polyurethane foam. This material choice allows, on the one hand, a favorably priced manufacture and, on the other hand, it makes it possible to give the pad element the advantageous properties which will be explained below.

The elasticity of the pad element is preferably chosen such that after a permanent or slow compression, in particular within a compression taking more than 0.5 s, it only returns to its relaxed state slowly, in particular within more than 20 s, preferably more than 60 s. This slow springing back of the pad element means that the pad element only expands slightly during a brief opening of the lock so that when the lock is subsequently locked, only very slight manual forces have to be applied in order to compress the pad element again. The operating comfort is thus increased, in particular with bicycle locks in accordance with the invention, since a bicycle lock is only opened briefly during locking or unlocking in order to release it from a holder on the bicycle side and subsequently to lock it or vice versa.

The slow springing back of the pad element further advantageously means that no high forces act on the lock bolt in the direction of its unlocked position when a lock in accordance with the invention is opened, so that the lock bolt does not suddenly jump out of the lock bolt recess when the lock is opened.

It is furthermore of advantage if the elasticity of the pad element is chosen such that after a fast or abrupt compression, in particular within a compression taking less than 0.1 s, it returns to its relaxed state quickly, in particular within less than 0.2 s, preferably less than 0.1 s. It is achieved by this property that when the pad element is compressed fast or abruptly, it practically has the action of a spring. A damping effect is achieved thanks to this property of the pad element when the lock is “shaken”, for example during a bicycle ride, and said damping effect results in only very slight relative movements still being possible between the lock bolt and the lock bolt recess so that finally a “rattling” of the lock in the case of vibrations is greatly reduced or even completely avoided.

It is preferred for the pad element to consist of a highly compressible foam, in particular when the pad element can be compressed to less than 20% of its relaxed volume under the application of manual force.

It is particularly preferred for the pad element to be compressible with a low force, in particular with a force from 0.2 N to 5 N, in particular from 1 N to 2 N, since the lock in accordance with the invention can be operated particularly comfortably in this manner due to the low amount of force required.

It is of advantage if the elasticity of the pad element is chosen such that it abuts the end face in a form-fitted manner in the locked state of the lock, and in particular also abuts the jacket regions of the lock bolt adjacent to the end face. This property means that when the lock is locked, the pad element fits snugly and precisely to the end face so that the pad element not only loads the end face of the lock bolt, but also the jacket regions or side surface of the lock bolt adjacent to the end face. In this way, therefore, a bias is generated via the end face of the lock bolt in the direction of the unlocked position and a bias is also generated via the jacket region directed radially inwardly, substantially perpendicular to the longitudinal axis of the lock bolt, so that finally the play of the lock bolt in the lock bolt recess is ultimately prevented both in the longitudinal direction of the lock bolt and transversely thereto.

It is furthermore preferred if the pad element is fixed to the bottom of the lock bolt recess in the lock housing, with the fixation being realized at least by an elastic clamping of the regionally compressed pad element between components of the lock housing adjacent to the compressed regions. Alternatively or additionally, it is naturally also possible to fix the pad element in the lock housing by an adhesive bond.

In a somewhat more complex embodiment of the invention, the lock bolt is provided with a stop element spaced from the front end of the lock bolt and from the latch recess, said stop element being adjacent to a stop surface of the lock housing in the locked state of the lock.

Since a separate stop element is provided in accordance with the invention at the lock bolt and this stop element directly abuts a corresponding stop surface of the lock housing in the locked state of the lock, possible play between the lock bolt and the lock bolt recess is taken up or compensated for, in addition to the action of the pad element in accordance with the invention, so that relative movements between the lock bolt and the lock bolt recess are reduced even further.

The stop element is preferably formed as a sleeve which comes to rest at least regionally outside the lock bolt recess in the locked state of the lock. The border of the lock bolt recess can, in this case, be formed as the stop surface for the stop element or for the sleeve.

When said sleeve is used, it is of advantage if it can be pushed simply onto commercial lock bolts, in particular onto commercial hoops of hoop locks, so that no design changes are necessary with respect to the lock bolt or hoop respectively. This embodiment can then also be realized in an extremely economical manner.

It is particularly preferred if the sleeve, or at least a part of the sleeve, is arranged adjustably in the axial direction of the lock bolt on the lock bolt. The sleeve can be moved so closely to the border or rim of the lock bolt recess due to such an adjustment possibility that play present between the lock bolt and the lock bolt recess is completely eliminated. Production tolerances in the lock bolt and lock bolt recess can additionally be compensated for without problems in this manner.

When the lock in accordance with the invention is formed as a hoop lock, it is of advantage if both hoop ends are each provided with one pad element in accordance with the invention and/or with one sleeve in accordance with the invention. A rattling of the hoop lock during transport is avoided particularly reliably in this manner.

Further preferred embodiments of the invention are described in the dependent claims.

The invention is explained in the following by way of example with reference to the drawings, in which are shown:

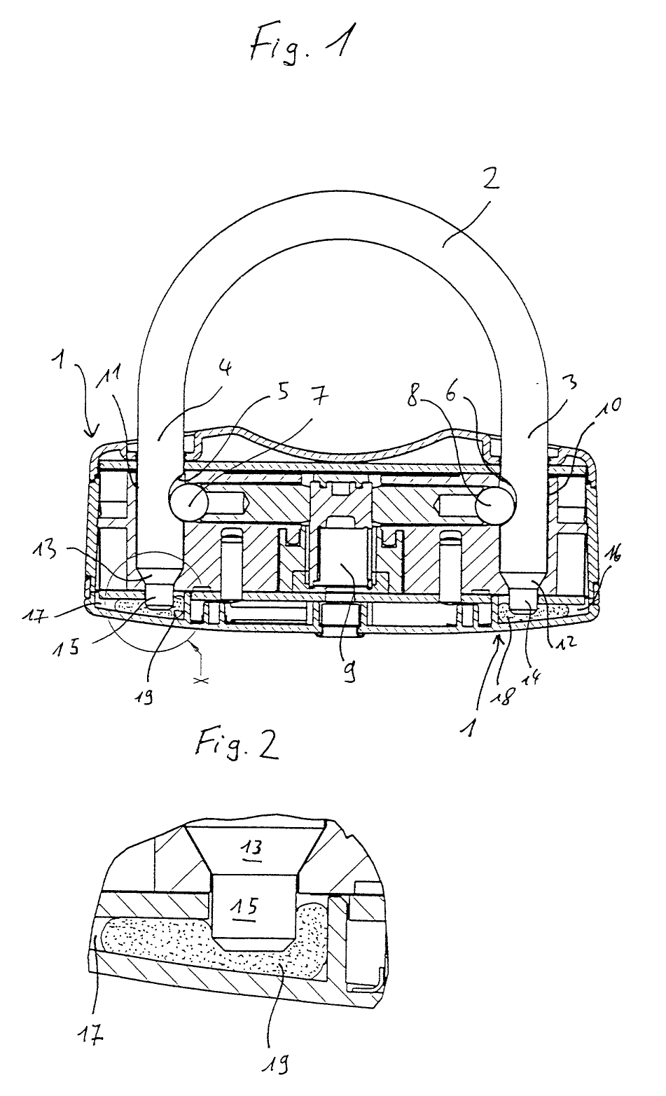

FIG. 1 a side view of a lock in accordance with the invention in its locked position, with a hoop of the lock being illustrated in a side view and the lock housing in a sectional view;

FIG. 2 a cut-away detailed view of the region marked with X in FIG. 1;

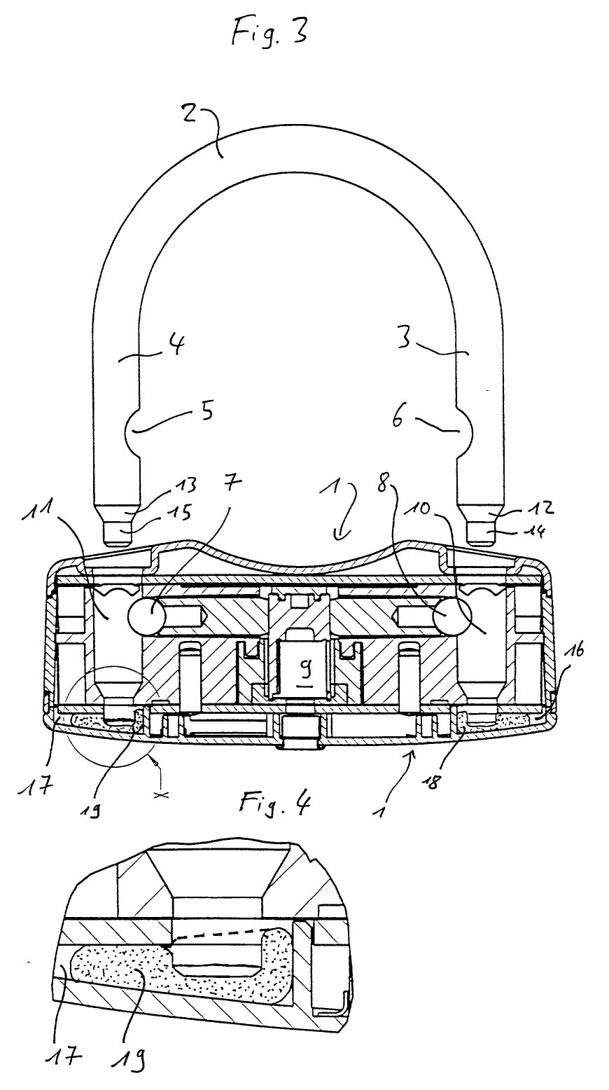

FIG. 3 an illustration in accordance with FIG. 2 with the hoop located in the open position; and

FIG. 4 a cut-away detailed view of the region marked with X in FIG. 3.

The hoop lock in accordance with the invention shown in FIG. 1 is constructed in a conventional manner and has a hoop 2 which can be locked in a lock housing 1, which is bent in a U-shape and which has a respective latch recess 5, 6 at each of its two legs 3, 4, with latch elements 7, 8 engaging into said latch recesses 5, 6 in the illustrated locked position of the lock. The latch elements 7, 8 can be loaded in a direction extending perpendicular to the longitudinal axis of the hoop leg 3, 4 by an actuating mechanism, with said actuating mechanism being moved by a lock cylinder 9.

The lock housing 1 has two lock bolt recesses 10, 11, into each of which a respective hoop leg 3, 4 can be inserted front end-first. In the locked position illustrated in FIG. 1, the two hoop legs 3, 4 are fully inserted in the lock bolt recesses 10, 11 and the lock is locked by the engagement of the latch elements 7, 8 in the latch recesses 5, 6.

The two ends of the hoop legs 3, 4 each have a truncated cone-like element 12, 13 tapering to their front-side ends, with two cylindrical heads 14, 15 adjoining thereto, which are chamfered in each case at their ends opposite to the truncated cone-like elements 12, 13.

When the hoop 2 is locked in the lock housing 1, the lower regions of the cylindrical heads 14, 15 extend in each case into a hollow space 16, 17 of the lock housing 1 on the bottom side, with these hollow spaces 16, 17 being filled at least regionally in each case with a pad element 18, 19 in accordance with the invention. The fastening of the pad elements 18, 19 in the hollow spaces 16, 17 can be effected, for example, simply by the pad elements 18, 19 being “shot” into the hollow spaces 16, 17 in compressed form, whereupon the pad elements 18, 19 are then clamped tight due to their expansion into the hollow spaces 16, 17.

The pad elements 18, 19 are positioned such that when the hoop 2 is completely locked in the lock housing 1, they are compressed in the direction of the longitudinal axis of the hoop legs 3, 4 by the front ends of the cylindrical heads 14, 15 so that finally the pad elements exercise a bias force on the hoop legs 3, 4 acting towards the unlocked position of the hoop 2 in the manner already described, in order to thus prevent the rattling of the lock in the case of vibrations.

It can be seen from the detailed view of FIG. 2 that the elasticity of the pad element 19 is chosen such that it snugly fits the shape of the cylindrical bolt 15 in a form-fitted manner when the hoop leg 4 is fully inserted into the lock bolt recess 11 so that play of the hoop leg 4 perpendicular to its longitudinal axis is also avoided.

FIGS. 3 and 4 show the lock of FIGS. 1 and 2 shortly after the hoop 2 has been unlocked from the lock housing 1. Since the elasticity of the pad elements 18, 19 has been chosen in the embodiment shown such that the pad elements 18, 19 return only slowly to their relaxed starting positions after a lasting compression, i.e. after the lock has been locked for at least several minutes, the pad elements 18, 19 have in accordance with FIGS. 3 and 4 substantially still the same shape adapted to the cylindrical heads 14, 15 as in FIGS. 1 and 2, which results in the advantages already explained above.

Only when the hoop 2 is in an unlocked state for a fairly long time, for example for several minutes, will the pad elements 18, 19 slowly return to their relaxed shape which is shown by a broken line in FIG. 4. However, the pad elements 18, 19 will also return to the position shown in FIGS. 1 and 2 starting from this position shown by a broken line, when the hoop 2 is again inserted into the lock housing 1 and locked in place there.

1. A lock, in particular a hoop or cable lock having a lock bolt (3, 4) which can be locked in place in a lock bolt recess (1) of a lock housing (1), characterized in that the lock bolt (3, 4) is loaded in the locked state of the lock by a pad element (18, 19) in the direction of its unlocked position via its end face.

2. A lock in accordance with claim 1, characterized in that the pad element (18, 19) is made of foam, in particular of fine-pored polyurethane foam.

3. A lock in accordance with claim 1, characterized in that the elasticity of the pad element (18, 19) is chosen such that after a permanent or slow compression, in particular within a compression taking more than 0.1 s , it only returns to its relaxed state slowly, in particular within more than 20 s, preferably more than 60 s.

4. A lock in accordance with claim 1, characterized in that the elasticity of the pad element (18, 19) is chosen such that after a fast or abrupt compression, in particular within a compression taking less than 0.1 s, it returns to its relaxed state quickly, in particular within less than 0.2 s, preferably less than 0.1 s.

5. A lock in accordance with claim 4, characterized in that the pad element (18, 19) has at least approximately the action of a spring after a fast or abrupt compression, in particular within a compression taking less than 0.1 s.

6. A lock in accordance with claim 1, characterized in that the pad element (18, 19) is made of a highly compressible foam.

7. A lock in accordance with claim 6, characterized in that the pad element (18, 19) can be compressed to less than 20% of its relaxed volume under the action of a manual force.

8. A lock in accordance with claim 1, characterized in that the pad element (18, 19) can be compressed with a low force, in particular with a force from 0.2 N to 5 N, in particular 1 N to 2 N.

9. A lock in accordance with claim 1, characterized in that the elasticity of the pad element (18, 19) is chosen such that it abuts the end face in a form-fitted manner in the locked state of the lock, and in particular also abuts the jacket regions of the lock bolt (3, 4) adjacent to the end face.

10. A lock in accordance with claim 1, characterized in that the pad element (18, 19) is fixed to the bottom of the lock bolt recess (10, 11) in the lock housing.

11. A lock in accordance with claim 10, characterized in that the fixation is realized at least by an elastic clamping of the regionally compressed pad element (18, 19) between components of the lock housing adjacent to the compressed regions.

12. A lock in accordance with claim 1, characterized in that the lock bolt (3, 4) is provided with a stop element spaced from the front end of the lock bolt (3, 4) and from a latch recess (5, 6), said stop element being adjacent to a stop surface of the lock housing (1) in the locked state of the lock.

13. A lock in accordance with claim 12, characterized in that the stop element is formed as a sleeve which comes to rest at least regionally outside the lock bolt recess (10, 1 1).

14. A lock in accordance with claim 12, characterized in that the border of the lock bolt recess (10, 11) is formed as a stop surface for the stop element or for the sleeve.

15. A lock in accordance with claim 13, characterized in that the border of the lock bolt recess (10, 11) is formed as a stop surface for the stop element or for the sleeve.

16. A lock in accordance with claim 13, characterized in that the sleeve is arranged adjustably in the axial direction of the lock bolt (3, 4) on the lock bolt (3, 4).

17. A lock in accordance with claim 1, characterized in that both hoop ends or lock bolts (3, 4) of a hoop lock are each loaded by one pad element (18, 19) in the direction of their unlocked position via their end faces in the locked state of the lock.

18. A lock in accordance with claim 1, characterized in that both hoop ends (3, 4) of a hoop lock are each provided with a sleeve in accordance with claim 13.
